(19) United States
(12) Patent Application Publication
(10) Pub. No.: US 2010/0178827 A1
(43) Pub. Date: Jul. 15, 2010

(54) ROOF UNDERLAYMENT

(75) Inventors: Hwee Tatz Thai, Singapore (SG); Han IL Lee, Broomfield, CO (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E.I.DU PONT DE NEMOURS AND COMPANY, Wilmington, DE (US)

(21) Appl. No.: 12/505,301

(22) Filed: Jul. 17, 2009

Related U.S. Application Data
(60) Provisional application No. 61/081,556, filed on Jul. 17, 2008.

(51) Int. Cl. B32B 5/26; B32B 27/12; B32B 27/02

(52) U.S. Cl. 442/245; 442/243; 442/244; 442/246; 442/247; 442/261; 442/268; 442/392; 442/389; 442/382

(57) ABSTRACT

A roofing underlayment comprising a top layer, a bottom layer and a water-sealing composition layer positioned between the top layer and the bottom layer wherein the water-sealing composition consists essentially of at least 80 weight % of a copolymer of ethylene and at least one comonomer selected from the group consisting of alkyl acrylate, alkyl methacrylate and vinyl acetate is disclosed. The top and bottom layers independently comprise a fabric selected from the group consisting of nonwoven polypropylene, nonwoven polyethylene, nonwoven polyethylene terephthalate, woven polypropylene, woven polyethylene, spunbond polypropylene, and spunbond polyester. The roofing underlayment may optionally comprise additional layers.

This application claims priority to U.S. provisional application No. 61/081,556, filed Jul. 17, 2009; the entire disclosure of which is incorporated herein by reference.

This invention relates to a roof underlayment comprising a thermoplastic copolymer.

### BACKGROUND

Roofing structures for buildings typically include an underlayment and an overlayment. The overlayment, such as asphalt shingles, tiles, wooden shakes, slate tiles, metal roofing, low-pitch polyurethane spray foam systems, or the like, is intended to provide protection from external weather conditions like wind, rainwater and snowmelt. The underlayment is installed between the roof deck and the overlayment, and it further protects against moisture and other elements which may pass under the overlayment.

Underlayments have conventionally been produced by coating a layer of organic paper with a certain density of asphalt or bitumen and are stored in rolls (building felts).

Conventional bitumen underlayments become slippery when exposed to fluids, such as rain or dew, or are covered in dust. Also, asphalt-based roof underlayments are manufactured using a release agent, such as silica, to prevent the asphalt from sticking to itself in the roll. The release agent creates a slippery surface for workers installing asphalt based roofing felts.

Recently, non-bituminous underlayments have been sold in the United States including Tri-Flex 30 (sold by Flexia Corporation), Titanium UDL (sold by Interwrap Corporation), Roof Guard (sold by Rosenlew, Finland) and Roofshield (Roof Shield USA L.L.C.). These materials are hybrids of two or more polymeric sheets that are laminated using adhesives or by heat welding. Tri-Flex 30 is a spunbonded polypropylene with a thin coating of polypropylene on both sides. Titanium UDL is a coated woven construction consisting of two layers of polypropylene film. Roof Guard is a multi-layered laminated polyethylene roofing underlayment. Roofshield is a porous spun bonded polypropylene fabric sold as an underlayment. Such products are lightweight, possess good tensile and tear strengths, offer excellent water resistance, do not wrinkle, rot or crack, and have good lay-flat properties.

Other synthetic underlayments have been proposed which provide slip resistant surfaces. For example, US Patent Application Publication 2008/0020662 discloses a roof underlayment comprising a woven polypropylene scrim laminated to a top layer made from a non-woven spun-bond polypropylene fabric. During lamination, the scrim is bonded to the top layer by a polypropylene coating that impregnates the scrim, thereby forming a structural bottom layer comprising the polypropylene-impregnated scrim.

US Patent Application Publication 2004/0127120 discloses an underlayment comprising a laminate having at least three layers, an upper layer of extruded high density polyethylene or low density polyethylene film, a middle layer of lightweight scrim, a bottom layer of spun bonded polypropylene fabric, the middle layer being attached to said upper layer by a first adhesive layer, and the middle layer and the bottom layer being connected by a second adhesive layer.

US Patent Application Publication 2007/0044397 discloses a roofing underlayment comprising at least one support layer having first and second opposite major surfaces, and a pressure sensitive layer attached to said first major surface of said at least one support layer, such that upon application of said underlayment to a roof, the pressure sensitive layer provides a skid resistant surface. Embodiments include those wherein the support layer is a woven or nonwoven fabric, a polyolefin film or spun bonded polypropylene or woven polypropylene.

For most residential applications, underlayment is laid on the inclining surface of a wooden support deck and nailed to it. However, the nails puncture the underlayment and leaks can occur around the nail punctures. Currently, bitumen is applied over the nail heads to act as a sealant to prevent water seepage of rain water through the punctured underlayment. This practice is labor intensive and adds to the time and expense of installing a roof.

The waterproofing properties of the underlayment are very much dependent on the quality of the bitumen used. Prolonged exposure to the environment may result in hardening of unmodified bitumen. This may decrease its adhesion and flow properties and an increase in the softening point temperature and coefficient of thermal expansion. Hardening of bitumen results in a reduction in its ability to accommodate deformations without splitting or cracking.

Non-bituminous underlayments may also suffer from water infiltration when nailed to the roof deck.

A need therefore exists for a roofing underlayment that provides good waterproofing properties when punctured by roofing nails.

### SUMMARY OF THE INVENTION

This invention provides a roofing underlayment comprising or consisting essentially of

(a) a top layer comprising a fabric including or selected from the group consisting of nonwoven polypropylene, nonwoven polyethylene, nonwoven polyethylene terephthalate; woven polypropylene, woven polyethylene, spunbond polypropylene, spunbond polyester, or combinations of two or more thereof;

(b) a bottom layer comprising a fabric including or selected from the group consisting of nonwoven polypropylene, nonwoven polyethylene, nonwoven polyethylene terephthalate; woven polypropylene, woven polyethylene, spunbond polypropylene, spunbond polyester, or combinations of two or more thereof; and

(c) a composition layer positioned between the top layer and the bottom layer wherein the composition comprises at least 80 weight % of a copolymer of ethylene and at least one comonomer selected from the group consisting of alkyl acrylate, alkyl methacrylate or vinyl acetate.

### DETAILED DESCRIPTION OF THE INVENTION

All references disclosed herein are incorporated by reference.

Unless stated otherwise, all percentages, parts, ratios, etc., are by weight. Further, when an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range. When a component is indicated as present in a range starting from 0, such component is an optional component (i.e., it may or may not be present).

“Copolymer” refers to polymers containing two or more monomers. Dipolymer means that the copolymer has two comonomers. The term terpolymer and/or termonomer means that the copolymer has at least three different comonomers.

“Consisting essentially of” means that the recited components are essential; smaller amounts of other components may be present to the extent that they do not detract from the operability of this invention.

The term “(meth)acrylic acid” refers to methacrylic acid and/or acrylic acid, inclusively and “(meth)acrylate” means methacrylate and/or acrylate.

“Bottom layer” refers to the layer of the roofing underlayment that is applied closest to the roof decking and “top layer” refers to the layer of the underlayment that is applied farthest from the roof decking.

The roofing underlayment comprises a composition layer positioned between a top layer and a bottom layer wherein the composition consists essentially of at least 80 weight % of a copolymer of ethylene and at least one comonomer selected from the group consisting of alkyl acrylate, alkyl methacrylate or vinyl acetate. This composition has excellent adhesion to substrates such as PET or PE film, woven and non-woven PP and HDPE, non-woven PET, spunbond PP and PET etc. for preparing multilayer structures for use as a roof underlayment. This composition, when used as an adhesive layer between substrates provide excellent resistance to water penetration after being punctured by nails when used as a roof underlayment. Other advantages of using such compositions in place of bitumen include lower thickness, lighter weight, and non-staining. The compositions have better weather properties than bitumen. Bitumen can crack at low temperature and soften at high temperature. Bitumen also “ages down,” hardening over time, resulting in increased cracking. Using the compositions also provides for cleaner and faster processes for making the underlayment.

The ethylene copolymer used in the roofing underlayment is an ethylene copolymer comprising units derived from ethylene copolymerized with at least one polar monomer such as vinyl acetate, alkyl acrylate, or alkyl methacrylate. Additional comonomers may also be incorporated as copolymerized units in the ethylene copolymer. Suitable copolymerizable monomers include carbon monoxide, methacrylic acid acrylic acid, maleic anhydride, maleic acid, maleic acid monoalkyl esters, or combinations of two or more thereof.

The ethylene copolymer includes ethylene copolymers such as ethylene/vinyl acetate copolymers, ethylene/acrylic ester copolymers, ethylene/methacrylic ester copolymers, ethylene/vinyl acetate/CO copolymers, ethylene/acrylic ester/CO copolymers, or combinations of two or more thereof.

The composition may comprise at least one ethylene/vinyl acetate copolymer, which includes copolymers derived from the copolymerization of ethylene and vinyl acetate or the copolymerization of ethylene, vinyl acetate, and an additional comonomer.

The amount of the vinyl acetate comonomer incorporated into the ethylene/vinyl acetate copolymers can vary from a few (e.g., 3) weight % up to as high as 45 weight % of the total copolymer, or even higher.

The ethylene/vinyl acetate copolymer may have from 2 to 45 or 6 to 35 weight % derived from vinyl acetate, preferably 15 to 35 weight %. The ethylene/vinyl acetate copolymer may optionally be modified by methods well known in the art, including modification with an unsaturated carboxylic acid or its derivatives, such as maleic anhydride or maleic acid. The ethylene/vinyl acetate copolymer may have a melt flow rate measured in accord with ASTM D-1238 of from 0.1 to 60 g/10 or 0.3 to 30 g/10 minutes. A mixture of two or more different ethylene/vinyl acetate copolymers can be used. Suitable examples of the ethylene vinyl acetate copolymer include those commercially available from E. I. du Pont de Nemours and Company, Wilmington, Del. (DuPont) under the tradename ELVAX.

Preferably, the composition comprises at least one ethylene/alkyl (meth)acrylate copolymer, which includes copolymers of ethylene and one or more C₁₋₈ alkyl acrylates or methacrylates, preferably C₁₋₄ alkyl acrylates or methacrylates. Examples of alkyl (meth)acrylates include methyl acrylate, ethyl acrylate, butyl acrylate and methyl methacrylate. Examples of the copolymers include ethylene/methyl acrylate copolymer ethylene/ethyl acrylate copolymer, ethylene/butyl acrylate copolymer, or combinations of two or more thereof.

Alkyl (meth)acrylate may be incorporated into an ethylene/alkyl (meth)acrylate copolymer from a few weight % up to about 45 weight % of the copolymer, such as 5 to 45 or 10 to 28 weight %, preferably 10 to 35 weight %. Frequently used alkyl groups include methyl, ethyl, iso-butyl, or n-butyl. The ethylene/alkyl (meth)acrylate copolymers can vary in alkyl (meth)acrylate weight %, molecular weight and melt index (MI).

Ethylene/alkyl (meth)acrylate copolymers can be prepared by processes well known to one skilled in the art using either autoclave or tubular reactors. See, e.g., U.S. Pat. Nos. 2,897,183, 3,404,134, 5,028,674, 6,500,888, and 6,518,365. See also, Richard T. Chou, Mimi Y. Keating and Lester J. Hughes, “High Flexibility EMA made from High Pressure Tubular Process”, Annual Technical Conference—Society of Plastics Engineers (2002), 60^{th} (Vol. 2), 1832-1836. Because the methods for making an ethylene/alkyl (meth)acrylate copolymer are well known, the description of which is omitted herein in the interest of brevity. Tubular reactor produced ethylene/alkyl (meth)acrylate copolymers, are commercially available from DuPont as ELVALOY AC.

Tubular reactor produced ethylene/alkyl (meth)acrylate copolymers may have higher temperature resistance (about 10 to 15° C.) than ethylene/alkyl (meth)acrylate copolymers having the same comonomer weight % and same MI produced using autoclave reactors. Higher service temperature can be a factor in areas with very hot conditions in summer such as Texas, Florida, Colorado, etc.

A mixture of two or more different ethylene/alkyl (meth)acrylate copolymers can be used.

The composition used in the underlayment comprises or consists essentially of at least, by weight, 80, 90, 95, or 100%, of the ethylene copolymers disclosed above. The composition may further contain polyethylene homopolymers, polyethylene copolymers, propylene homopolymers (PP), propylene copolymers, E/P copolymer, polyester, or combinations of two or more thereof. For example, the composition may contain small amounts of these polymers resulting from recycling scrap, trimmings and the like created during preparation of the multilayer underlayment, disclosed below, provided that the composition contains at least about 80% of the ethylene copolymers.

Polyethylene homopolymers and copolymers can be prepared by a variety of methods, for example, the well-known Ziegler-Natta catalyst polymerization (e.g., U.S. Pat. No. 4,076,698 and U.S. Pat. No. 3,645,992), metallocene catalyzed polymerization, VERSIPOL catalyzed polymerization and by free radical polymerization. The polymerization can be conducted as solution phase processes, gas phase processes, and the like. Examples of PE polymers can include high density PE (HDPE), linear low density PE (LLDPE), low density PE (LDPE), very low or ultralow density polyethylenes (VLDPE or ULDPE), lower density PE made with metallocene having high flexibility and low crystallinity (mPE). Metallocene technology is described in, for example, U.S. Pat. Nos. 5,272,236, 5,278,272, 5,507,475, 5,264,405, and 5,240,894. Of note are compositions comprising low density PE.

The densities of polyethylenes suitable can range from about 0.865 g/cc to about 0.970 g/cc. Linear polyethylenes can incorporate α-olefin comonomers such as butene, hexene or octene to decrease density to within the density range so described. For example, a copolymer used may comprise a major portion (by weight) of ethylene that is copolymerized with another α-olefin having about 3 to about 20 carbon atoms and up to about 20% by weight of the copolymer. Other α-olefins include propylene, 1-butene, 1-hexene, 4-methyl-1-pentene, 1-octene, 1-decene, 1-tetradecene, 1-octadecene, or in admixtures of two or more.

The PE copolymer may also be an ethylene propylene elastomer containing a small amount of unsaturated compounds having a double bond. “Polyethylene” is used generically to refer to any or all of the polymers comprising ethylene described above.

Ethylene copolymers having small amounts of a diolefin component such as butadiene, norbornadiene, hexadiene and isoprene are also generally suitable. Terpolymers such as ethylene/propylene/diene monomer (EPDM) are also suitable.

Polypropylene polymers include homopolymers, random copolymers, block copolymers and terpolymers of propylene. Copolymers of propylene include copolymers of propylene with other olefins such as ethylene, 1-butene, 2-butene and the various pentene isomers, etc. and preferably copolymers of propylene with ethylene. Terpolymers of propylene include copolymers of propylene with ethylene and one other olefin. Random copolymers, also known as statistical copolymers, are polymers in which the propylene and the comonomer(s) are randomly distributed throughout the polymeric chain in ratios corresponding to the feed ratio of the propylene to the comonomer(s). Block copolymers are made up of chain segments consisting of propylene homopolymer and of chain segments consisting of, for example, random copolymers of propylene and ethylene.

Polypropylene homopolymers or random copolymers can be manufactured by any known process (e.g., using Ziegler-Natta catalyst, based on organometallic compounds, or on solids containing titanium trichloride, or metalecene catalyst).

Block copolymers can be manufactured similarly, except that propylene is generally first polymerized by itself in a first stage and propylene and additional comonomers such as ethylene are then polymerized, in a second stage, in the presence of the polymer obtained during the first. Each of these stages can be carried out, for example, in suspension in a hydrocarbon diluent, in suspension in liquid propylene, or else in gaseous phase, continuously or noncontinuously, in the same reactor or in separate reactors. See, e.g., chapters 4.4 and 4.7 of the work “Block Copolymers” edited by D. C. Allport and W. H. Janes, published by Applied Science Publishers Ltd., 1973.

Polyester is well known to one skilled in the art and can include any condensation polymerization products derived from, by esterification or transesterification, an alcohol and a dicarboxylic acid including ester thereof. Alcohols include glycols having 2 to about 10 carbon atoms such as ethylene glycol, propylene glycol, butylene glycol, propanediol, methoxypolyalkylene glycol, neopentyl glycol, trimethylene glycol, tetramethylene glycol, hexamethylene glycol, diethylene glycol, polyethylene glycol, cyclohexane dimethanol, or combinations of two or more thereof. Dicarboxylic acids include terephthalic acid, succinic acid, adipic acid, azelaic acid, sebacic acid, glutaric acid, isophthalic acid, 1,10-decanedicarboxylic acid, phthalic acid, dodecanedioic acid, ester-forming equivalent (e.g., diester such as dimethylphthalate), or combinations of two or more thereof. Frequently used polyesters include polyethylene terephthalate (PET), polytrimethylene terephthalate (PTT), polypropylene terephthalate (PBT), polyethylene naphthalenedioate (PEN), or combinations of two or more thereof. Because polyester and processes for making polyester are well known to one skilled in the art, the description of these is omitted herein in the interest of brevity.

The ethylene copolymer compositions described above, when used as an inside layer of a multilayer roof underlayment provides excellent leak resistance properties when punctured by a nail. Without being bound by any theory, the water-sealing composition has suitable stress relaxation and strain recovery upon stretching that allow it to tightly conform to the outside surface of the nail.

When used in a roofing underlayment, the water-sealing composition can be between a top layer and a bottom layer in a multilayer structure. The top and bottom layers can be independently selected from the group consisting of nonwoven polypropylene, nonwoven polyethylene, nonwoven polyethylene terephthalate; woven polypropylene, woven polyethylene, spunbond polypropylene, and spunbond polyester. Optionally, additional layer(s) may also be present, such as polyethylene or polyester layers. The top, bottom and optional additional layers when present provide structure, bulk and/or stiffness to the underlayment. The top and bottom layers may also provide slip-resistant surfaces and protect the water-sealing composition during storage, transport and installation of the roof underlayment and overlayment.

An embodiment of the roofing underlayment is one wherein the water-sealing composition layer is directly adhered to the bottom layer. Another embodiment is one wherein one face of the composition layer is directly adhered to the bottom layer and the other face of the composition layer is directly adhered to the top layer.

Another embodiment further comprises a layer comprising polyethylene or polyester applied between the water-sealing composition layer and the top layer. A particular embodiment is one wherein one face of the composition layer is directly adhered to the bottom layer and the other face of the composition layer is directly adhered to the polyethylene or polyester layer.

Other embodiments are those wherein a second water-sealing composition layer is positioned between the polyethylene or polyester layer and the top layer and the second composition consists essentially of at least 80 weight % of a copolymer of ethylene and at least one comonomer selected from the group consisting of alkyl acrylate, alkyl methacrylate or vinyl acetate. Also an embodiment is one wherein one face of the second composition layer is directly adhered to the top layer and the other face of the second composition layer is directly adhered to the polyethylene or polyester layer. In these embodiments, the first and second water-sealing compositions may be the same or different.

Another embodiment of the roofing underlayment is one wherein the water-sealing composition layer is directly adhered to the top layer. Another embodiment further comprises a layer comprising polyethylene or polyester applied between the water-sealing composition layer and the bottom layer. A particular embodiment is one wherein one face of the composition layer is directly adhered to the top layer and the other face of the composition layer is directly adhered to the polyethylene or polyester layer.

When a layer comprising polyethylene or polyester is present in the multilayer underlayment, it may be adhered to the top or bottom layer with either the water sealing composition or with another adhesive composition. For example, a LDPE composition may be used as an adhesive layer between a polyethylene layer and a spunbond PET bottom or top layer. This layer may comprise pigments or coloring agents such as titanium dioxide or carbon black.

Although the water-sealing composition layer may be in any location inside the underlayment, it may be desirable to have it located adjacent to the bottom layer. Having it in this location may provide better sealing, since the other overlying layers may contribute to inhibiting water penetration from above.

The roofing underlayment may be manufactured using an extrusion lamination process, in which the adhesive water-sealing composition is applied between the top layer and the bottom layer as a curtain of molten polymer. For example, the lamination apparatus comprises a pair of master rolls respectively containing a rolled sheet of the bottom layer fabric and a rolled sheet of the top layer fabric. The top layer fabric is passed over a guide roller and then into a lamination nip sequence formed between a nip roller and a chill roller, while the water-sealing composition is being extruded in a liquid state from an extruder between the top and bottom layers. Specifically, the top layer fabric is laminated to the bottom layer fabric as the extruded water-sealing composition is applied to the bottom side of the top layer fabric just before the top layer fabric and the bottom layer fabric pass between the nip roller and the chill roller. Thus, as the bottom fabric, the molten water-sealing composition, and the top layer fabric pass between the nip roller and the chill roller, the bottom layer fabric and the top layer fabric are pressed together, causing the water-sealing composition to be adhered to the fabric of the top and bottom layers as the layers are laminated together. In some cases, the type of top and/or bottom layer fabric (such as woven fabric) may allow for the water-sealing composition to be partially impregnated into the top and/or bottom layer during the lamination process. The amount of water-sealing composition and the nip pressure between the nip roller and the chill roller can be sufficient to press the top and bottom layer fabric into the water-sealing composition so that the layers are adhered. The underlayment is then transferred to a master roll and then processed into finished rolls.

Embodiments which comprise additional layer(s) may be prepared similarly, wherein the water-sealing composition is directly adhered to the top layer and an additional layer. For example, a roofing underlayment may be prepared by adhering the top layer fabric to one face of a polyethylene or polyester film using the water-sealing composition as an adhesive layer and simultaneously or consecutively adhering the other face of the polyethylene or polyester film to the bottom layer fabric using the water-sealing composition as an adhesive layer.

The roofing underlayment described above is flexible and may be formed into rolls which can be simply unrolled over a roof support structure to allow for easy installation. The underlayment is advantageously used as an underlayment for asphalt shingles. By using the underlayment when installing asphalt shingles, the life of the roof is enhanced, as the underlayment provides long-term moisture protection, improved durability, wind resistance, enhanced elimination of blow-off and resistance to hail damage. The underlayment may be used as an alternate to Type 15 and Type 30 roofing felts (asphalt coated paper based).

The underlayment is resistant to thermal expansion and contraction, wrinkling, absorbing moisture, scarring, and melting. It withstands high temperatures, and it resists rotting, drying out, or becoming brittle. The underlayment also provides added protection against wind and hail.

The water-sealing composition provides for a synthetic roof underlayment that, when mechanically fastened with nails, provides nail sealability as per ASTM 1970 per ICBO AC 48 Severe Weather Climate Roof Underlayments standards.

The conventional method of installing current synthetic polymer roof underlayments requires a plastic cap attached to a number 12 gauge nail shank. The caps provide a larger surface area to hold the current synthetic polymer roof underlayments to the conventional wood sheathing, plywood or OSB deck, as the heads of the larger nails are needed to increase the nail head-to-underlayment contact area, thus reducing the probability of tearing at the nails. However, the underlayment may have sufficient tear resistance so that standard ⅜ inch nails can be used for installation without the need for plastic caps. In laboratory testing, the underlayment was tested without plastic caps and no tearing of the structure was found with screw or ring-type nails. Nailing the underlayment without plastic caps may speed installation, as hand-driven ⅜ inch nails install faster without the plastic caps. In addition, a standard ⅜ inch coil gun can be used, which is the standard nail gun typically used by asphalt shingle installers. Thus, the underlayment described herein may obviate the need for a separate tool to install the underlayment, while providing better sealing at the nail head, and also eliminating the dimpling of metal standing roof panels caused by plastic capped nails.

Alternatively, instead of nailing the underlayment to the roof, the underlayment can be installed using an adhesive layer, such as a hot melt pressure sensitive adhesive, asphalt, SBS-modified asphalt, and/or butyl-modified adhesives known to those in the industry. For example, a butyl-modified hot melt pressure sensitive adhesive made by Alpha Systems Inc., or a thermoplastic pressure sensitive hot melt adhesives made by Q'SO Inc. can be used. Other suitable adhesives are well-known and commercially available. The adhesive layer is applied to the bottom surface (the surface opposite the layer of water-sealing composition) of the bottom layer fabric, and may be covered with a removable film/split film release liner. When the underlayment is installed, the film is peeled away from the underlayment and the underlayment is applied to the roof structure. By using an adhesive layer, the underlayment becomes mechanically bonded to the roof structure, and it provides additional structural support to keep a roof intact during strong sustained winds.

The top surface of the finished roof underlayment may advantageously be surface treated by passing it under a “corona treater,” which reduces static build-up that may cause production or quality problems, and which provides adhesion for printing as well as proper adhesion of polyurethane foam adhesives to bond with the non-woven surface layer of the roof underlayment.

In an embodiment, the top layer is advantageously white or grey in color, as these colors keep the underlayment up to 30% cooler for workers and keep buildings cooler during construction in summer months, while black may be used in winter months to help increase snow and ice melt from the roof. Furthermore, additives can be added to the coating and/or any of the layers to protect the underlayment from sun damage. Such additives may include, for example, ultra-violet protective additives to protect the underlayment while exposed prior to installation of the primary roof coverings and anti-oxidants to resist oxidation from heat cycling after the primary roof covering is installed.

Overlap lines and inner and outer layout lines can be printed on the top layer of the underlayment to guide in the installation of the roof. The overlap lines indicate where to overlap succeeding strips of underlayment, and by how much, as the underlayment is installed from the bottom of the roof to the top of the roof. Once a first strip of the underlayment has been installed, the bottom edge of the subsequent underpayment strip aligns with the overlap line on the previous strip, providing the workers with the exact location to install the subsequent underlayment strip. As a result, the laying of shingles or other overlayment materials stays consistent all the way to the top.

For example, overlap lines are preferably printed 3 inches from, and parallel with, the upper and lower edges of the underlayment strip that is of standard 48-inch width. Other distances from the edges may be used, depending on the width of the strip and the size of the shingles in the overlayment. The overlap lines indicate where to overlap succeeding strips of underlayment, and by how much to overlap the succeeding strips of underlayment, as the underlayment is installed from the bottom of the roof to the top of the roof. Once a first strip of the underlayment has been installed, a second strip can be installed in a right-to-left or left-to-right direction, parallel and horizontal to the first strip and so on, with subsequent underlayment strips overlapping the previous strip up to the overlap line on the upper edge of the previous strip, providing workers with the exact location to install each strip of underlayment relative to the previous strip. The underlayment strip is symmetrical top-to-bottom, so the installer does not have to start at the same side of the roof deck to install the strip.

In addition to the printed overlap lines, outer and inner layout lines may be printed on the strips to provide a consistent layout for each course of asphalt shingles from eave to ridge. In summary, the roof underlayment has overlap lines on the top and bottom horizontal longitudinal edges of the strip along with outer and inner layout lines so that each and every course of shingles, from the starter course at the roof eave and the field courses from the eave to the ridge of the roof, is provided with the correct alignment line for the asphalt shingles over the course of the roof. As a result, the laying of the shingles stays consistent all the way to the top of the roof.

For example, the underlayment strip is 48 inches wide, and the overlap lines are located 3 inches from the upper and lower edges. Between the overlap lines and each of the upper and lower edges, the outer layout lines and an array of parallel inner layout lines are printed every 5.625 inches, starting 1.5 inches from the lower edge and ending 1.5 inches from the upper edge. The layout lines provide a guide for consistently laying the shingles. The top edge of each row of overlayment asphalt shingle elements aligns with either of the outer layout lines. By overlapping each underlayment by three inches and following the layout lines the overlayment elements may be consistently laid all the way to the top of the roof. When conventional metric asphalt shingles are used, the dimensions of metric asphalt shingles conform to the layout lines on the underlayment strip. In alternative embodiments, any type of asphalt shingle, metal shingle, slate shingle, or tile shingle can be used, as the printed layout lines can be used as a straight edge to determine a predetermined distance that is substantially followed when installing a roofing unit that is installed with a relative overlap to the manufacturer's installation instructions. The printed layout lines of the underlayment strip may aid in the speed and quality of installing a roof.

The underlayment strip may have the addition of one-inch adhesive strips located above or below and parallel to the layout lines. Additionally, the outer layout lines, which face the bottom side of a subsequent underlayment strip that overlaps a previous underlayment strip, allow for a sealing strip that bonds the subsequent underlayment strip to the top side of previous underlayment strip. Thus, wind driven rain is inhibited from blowing between the horizontal longitudinal overlaps of underlayment strips.

The underlayment allows for installing concrete or clay roofing tiles with polyurethane spray foam adhesive. The polyurethane foam is sprayed onto the surface of the underlayment and bonds with the surface and provides an anchor for concrete and clay roof tiles, which are then set into the foam.

Commercial grade roofing systems have a low-slope roof pitch surface, and rolls of underlayment are unrolled on the roof surface, so that the underlayment may be mechanically fastened to an existing wood or metal low-slope deck, or installed using a pressure sensitive adhesive-coated version to concrete, steel or wood low-slope roofing. When installing a new roof on a commercial building with conventional underlayments, the original roof may sometimes be taken off, as TPO-type peel-and-stick commercial roofing materials do not attach well to the typical asphalt overlayment used in such applications. However, these underlayments can be installed directly on top of the original commercial roof by use of mechanical fasteners. As a result, the original roof may not have to be removed, and the new roof, a TPO-type, peel-and-stick backed commercial grade roofing material, such as Everguard by GAF, can be installed directly on top of the original roof. To accommodate the larger surface area of a commercial roof, the width of the underlayment strips on the rolls may be advantageously doubled to 96 inches.

The underlayments may also be used with polyurethane spray foam (PSF) in low-slope commercial and residential roof applications, particularly with a nonwoven top layer that is well-suited to bonding with PSF. PSF has been used for years in the roofing industry and is normally installed directly to the old roof surface or to a new roof deck, wall, and any number of other surfaces and applications. When re-roofing, the old roof is cleaned to remove rock, debris, and prepared prior to the application of the PSF. Where tar, asphalt, grease and other materials are present and do not allow for a proper bond when installing PSF, the underlayment can be installed mechanically to allow for a clean surface to which the PSF can be applied and provides an anchor sheet. The underlayments may reduce the labor and materials required to properly clean the existing roof while providing a superior attachment sheet to the roof deck structure. In the case of a roof tear-off at a later date, it also allows for easier of removal with standard tear-off equipment, because PSF is difficult to remove when applied directly to a roof deck. Additionally, the adhesive backed underlayment provides a level surface when installed over a fluted metal deck allowing for a flat surface on which to apply PSF instead of the conventional applications which may require the PSF to be used to fill in the flutes, which is a time consuming and difficult task if the installer is required to create a level and/or low-slope surface. The underlayments described herein can be installed on walls and other surfaces and other applications to which PSF can be applied.

### EXAMPLES

### Materials Used

EMA-1: An ethylene/methyl acrylate copolymer having 30 weight % of methyl acrylate and MI of 3 g/10 min.

PET-1: A spunbonded polyethylene terephthalate sheet with 30 g/m² basis weight.

LDPE-1: an extrusion-grade low density polyethylene with a melt index of 7 g/10 min.

LDPE-2: a commercially available black film 140μ thick prepared from low density polyethylene having melt index of 2 g/10 min.

PP-1: A spunbonded polypropylene sheet with 25 g/m² basis weight.

PET-2: a commercially available polyethylene terephthalate film of about 100-150μ thickness.

Bitumen: commercially available modified oxidized bitumen.

To assess the suitability of compositions for use as the water-sealing composition, monolayer films (summarized in Table 1) were prepared and the tensile strength was tested using the following method. On an INSTRON 3365 with a load cell of 100N and an available jaw separation of about 26 mm, sample films were stretched to 95% of extension (ramped at 13 mm/sec), returned to 85% of the jaw separation (22.1 mm) at 0.5 mm/sec and then held at 85% extension for 60 sec. The results are shown in Table 2.

TABLE 1

| Example | Composition | Thickness (μm) |
|---|---|---|
| 1 | EMA-1 | 100 |
| 2 | EMA-1 | 50 |
| 3 | EMA-1 | 30 |
| C1 | LDPE-1 | 100 |
| C2 | LDPE-1 | 50 |
| C3 | LDPE-1 | 30 |

TABLE 2

| | | Tensile stress at preset point (Mpa) | | |
|---|---|---|---|---|
| | | Extension | Extension | Extension 85% |
| Sample | Direction | 95% | 85% | (1 min later) |
| 1 | MD | 3.072 | 1.964 | 1.805 |
| 2 | MD | 3.019 | 1.829 | 1.687 |
| 3 | MD | 3.437 | 1.873 | 1.716 |
| C1 | MD | 11.963 | 5.916 | 6.458 |
| C2 | MD | 13.761 | 6.193 | 6.683 |
| C3 | MD | 17.628 | 6.827 | 7.39 |
| 1 | TD | 1.849 | 1.26 | 1.123 |
| 2 | TD | 1.99 | 1.356 | 1.205 |
| 3 | TD | 1.943 | 1.296 | 1.162 |
| C1 | TD | 10.048 | 4.879 | 5.616 |
| C2 | TD | 9.851 | 4.822 | 5.528 |
| C3 | TD | 9.7 | 4.65 | 5.308 |

The EMA-1 films showed lower tensile stress than the LDPE-1 films for the initial 95% stretching. The data also showed that EMA had better elastic recovery properties compared to LDPE. This was demonstrated by comparing the tensile stress at 85% stretching before and after holding for one minute. There was a relaxation (reduction) of stress in EMA but not LDPE. For LDPE, there was a stress build up. These results suggest that EMA-1 had elastic recovery properties desirable in a roof underlayment, while LDPE did not. Accordingly, an embodiment of the roofing underlayment is one wherein the water-sealing composition when stretched to 85% extension exhibits reduced tensile stress after holding at 85% extension for one minute compared to the initial tensile stress value.

Samples of the films were also tested using the INSTRON 3365 with a load cell of 100N by repeated stretching according to the method summarized in Table 3. The results are summarized in Table 4.

TABLE 3

| | |
|---|---|
| Cycle 1 | Ramp to 5% of the elongation 13 mm/sec, |
| | then return to 0% at 13 mm/sec. |
| Cycle 2 | Ramp to 10% of the elongation 13 mm/sec, |
| | then return to 0% at 13 mm/sec. |
| Cycle 3 | Ramp to 15% of the elongation 13 mm/sec, |
| | then return to 0% at 13 mm/sec. |
| Cycle 4 | Ramp to 20% of the elongation 13 mm/sec, |
| | then return to 0% at 13 mm/sec. |
| Cycle 5 | Ramp to 25% of the elongation 13 mm/sec. |
| | and then return to 0% at 13 mm/sec. |
| Cycle 6 | Ramp to 30% of the elongation 13 mm/sec, |
| | then return to 0% at 13 mm/sec. |
| Cycle 7 | Ramp to 35% of the elongation 13 mm/sec, |
| | then return to 0% at 13 mm/sec. |

TABLE 4

| | | Tensile stress at preset point (Mpa) | | | | | | |
|---|---|---|---|---|---|---|---|---|
| Sample | Direction | Strain 5% | Strain 10% | Strain 15% | Strain 20% | Strain 25% | Strain 30% | Strain 35% |
| 1 | MD | 0.29 | 0.89 | 1.33 | 1.66 | 1.93 | 2.17 | 2.33 |
| 2 | MD | 0.31 | 0.95 | 1.4 | 1.67 | 1.9 | 2.12 | 2.3 |
| 3 | MD | 0.13 | 0.84 | 1.35 | 1.63 | 1.82 | 2.14 | 2.4 |
| C1 | MD | 6.37 | 11.17 | 12.09 | 12.46 | 12.42 | 12.38 | 12.4 |
| C2 | MD | 6.26 | 10.79 | 11.58 | 11.99 | 12.12 | 12.3 | 12.5 |
| C3 | MD | 6.58 | 11.06 | 11.97 | 12.42 | 12.82 | 13.22 | 13.7 |
| 1 | TD | 0.21 | 0.73 | 1.06 | 1.27 | 1.43 | 1.57 | 1.63 |
| 2 | TD | 0.27 | 0.86 | 1.23 | 1.45 | 1.56 | 1.75 | 1.85 |
| 3 | TD | 0.05 | 0.68 | 1.08 | 1.26 | 1.35 | 1.54 | 1.68 |
| C1 | TD | 6.51 | 11.34 | 12.11 | 12.25 | 11.94 | 11.77 | 11.68 |
| C2 | TD | 6.75 | 11.02 | 11.45 | 11.46 | 11.22 | 11.11 | 11.06 |
| C3 | TD | 6.57 | 10.71 | 11.26 | 11.03 | 10.81 | 10.83 | 10.79 |

EMA-1 had excellent recovery properties (very low drop in elongation and also low residue stress after releasing of applied stress) compared to LDPE-1.

Multilayer laminates were prepared using extrusion lamination techniques. A first extrusion lamination pass laminated a spunbond PET-1 web and black LDPE-2 film with an adhesive composition (summarized in Table 5 as Tie Layer 1). A second extrusion lamination pass laminated a second spunbond PET-1 web to the first structure with Tie Layer 2 composition adhered between the black LDPE-2 film and the second spunbond PET-1 layer. When the multilayer structure was tested for waterproofing as described below, the side of the laminate with Tie Layer 2 was placed facing down.

The test to measure the ability to remain waterproof was conducted according to the test method of Japanese Architectural Standard Specification 12, issued by the Architectural institute of Japan.

The test piece, 70 mm×70 mm, was placed on a base of plywood, 70 mm×70 mm, and nailed to it using screw or ring shank nails. Nailing depth was equal to the depth of actual fixing (laying) with no clearance between the base and the test piece. Ten test units were prepared for each material tested. After nailing, a tube (cylinder) of 30 mm to 40 mm inside diameter was placed on the test material so that the nail penetration was centered in the end of the cylinder. The outer edge of the cylinder was sealed to the test material by application of caulk suitable for preventing water from flowing out of the cylinder.

After curing the seal, the cylinder was filled with to a level of 150 mm, and the test unit was allowed to be at rest for a period of at least 24 hours. At the end of a given period, evidence for water leakage through nail holes was checked. To pass, at least 8 of 10 nail holes on the base showed no water leakage.

The results of the testing are summarized in Table 5.

TABLE 5

| Example | Tie Layer 1 (thickness in μm) | Tie Layer 2 (thickness in μm) | Leak Test |
|---|---|---|---|
| 4 | EMA-1 (100) | EMA-1 (100) | passed 5 weeks |
| 5 | EMA-1 (50) | EMA-1 (50) | passed 5 weeks |
| 6 | LDPE-1 (80) | EMA-1 (80) | passed 5 weeks |
| 7 | LDPE-1 (50) | EMA-1 (50) | passed 5 weeks |
| C4 | 1:1 mixture of EMA-1 + LDPE-1 (100) | 1:1 mixture of EMA-1 + LDPE-1 (100) | failed within 24 hours |

The results summarized in Table 5 show that excellent water sealing properties could be achieved when using an ethylene/methyl acrylate dipolymer as the water sealing layer. However, water sealing was significantly reduced when the EMA was mixed with an equal amount of LLDPE (Comparative Example C4).

Five commercial structures using bitumen as a tie layer were tested for comparison. Four of five leaked after a few hours of testing (24 hours was required to pass the test). Only one passed 24 hours of testing but failed on a second day (less than 48 hours)

1. A roofing underlayment comprising a top layer, a bottom layer, and a water-sealing layer wherein
the top layer is the layer of the underlayment that is applied farthest from a roof decking;
the top layer is nonwoven polypropylene, nonwoven polyethylene, nonwoven polyethylene terephthalate, woven polypropylene, woven polyethylene, spunbond polypropylene, spunbond polyester, or combinations of two or more thereof;
the bottom layer is a fabric selected from the group consisting of nonwoven polypropylene, nonwoven polyethylene, nonwoven polyethylene terephthalate, woven polypropylene, woven polyethylene, spunbond polypropylene, spunbond polyester, and combinations of two or more thereof;
the water-sealing layer is positioned between the top layer and the bottom layer; and
the water-sealing layer is an ethylene copolymer consisting essentially of at least 80%, based on the weight of the layer, an ethylene copolymer of ethylene and a comonomer selected from the group consisting of alkyl acrylate, alkyl methacrylate, and vinyl acetate.

2. The roofing underlayment of claim 1 wherein the water-sealing layer comprises less than 20% of polyethylene homopolymers, polyethylene copolymers, propylene homopolymers, propylene copolymers, ethylene propylene copolymer, polyester, or combinations of two or more thereof.

3. The roofing underlayment of claim 1 wherein the water-sealing layer, when stretched to 85% extension, exhibits reduced tensile stress after holding at 85% extension for one minute compared to the initial tensile stress value.

4. The roofing underlayment of claim 1 wherein the water-sealing layer consists essentially of 100% of the ethylene copolymer and the comonomer is alkyl acrylate, alkyl methacrylate, vinyl acetate, or combinations of two or more thereof.

5. The roofing underlayment of claim 4 wherein the comonomer is C₁₋₈ alkyl acrylate or C₁₋₈ alkyl methacrylate.

6. The roofing underlayment of claim 5 wherein the ethylene copolymer contains 10 to 35% of C₁₋₈ alkyl acrylate, based on the weight of the copolymer.

7. The roofing underlayment of claim 6 wherein the comonomer is C₁₋₄ alkyl acrylate or C₁₋₄ alkyl methacrylate.

8. The roofing underlayment of claim 7 wherein the comonomer is methyl acrylate.

9. The roofing underlayment of claim 1 wherein the water-sealing layer is directly adhered, without intervening layer, to the top layer.

10. The roofing underlayment of claim 8 wherein one face of the water-sealing layer is directly adhered to the top layer and the other face of the water-sealing layer is directly adhered to the bottom layer.

11. The roofing underlayment of claim 1 further comprising a polyethylene layer or a polyester layer applied between the water-sealing layer and the top layer.

12. The roofing underlayment of claim 10 further comprising a layer comprising polyethylene or polyester applied between the water-sealing layer and the top layer.

13. The roofing underlayment of claim 11 wherein one face of the water-sealing layer is directly adhered to the bottom layer and the other face of the water-sealing layer is directly adhered to the polyethylene or polyester layer.

14. The roofing underlayment of claim 11 wherein the water-sealing layer consists essentially of 100 weight % of the ethylene copolymer and the comonomer is alkyl acrylate, alkyl methacrylate, vinyl acetate, or combinations of two or more thereof.

15. The roofing underlayment of claim 11 wherein a second water-sealing layer is positioned between the polyethylene or polyester layer and the top layer and the second water-sealing layer consists essentially of at least 80 weight % of the ethylene copolymer and the comonomer is alkyl acrylate, alkyl methacrylate, vinyl acetate, or combinations of two or more thereof.

16. The roofing underlayment of claim 14 wherein one face of the second water-sealing layer is directly adhered to the top layer and the other face of the second water-sealing layer is directly adhered to the polyethylene layer or the polyester layer.

17. The roofing underlayment of claim 14 wherein the second water-sealing layer consists essentially of 100 weight % of the ethylene copolymer and the comonomer is alkyl acrylate, alkyl methacrylate, vinyl acetate, or combinations of two or more thereof.

18. The roofing underlayment of claim 13 wherein the second water-sealing layer consists essentially of 100 weight % of the ethylene copolymer and the comonomer is alkyl acrylate, alkyl methacrylate, vinyl acetate, or combinations of two or more thereof.

19. The roofing underlayment of claim 1 wherein an adhesive layer is applied to the bottom surface of the bottom layer.

20. The roofing underlayment of claim 18 wherein an adhesive layer is applied to the bottom surface of the bottom layer.
